(19) United States
(12) Patent Application Publication
(10) Pub. No.: US 2021/0267166 A1
(43) Pub. Date: Sep. 2, 2021

(54) WRAP FOR PROTECTING THE HEAD AND HORN OF A STEER

(71) Applicant: Roy A. Brown, Downey, ID (US)

(72) Inventor: Roy A. Brown, Downey, ID (US)

(21) Appl. No.: 17/189,178

(22) Filed: Mar. 1, 2021

Related U.S. Application Data
(60) Provisional application No. 62/983,329, filed on Feb. 28, 2020.

(51) Int. Cl. A01K 13/00

(52) U.S. Cl. CPC A01K 13/006

(57) ABSTRACT

A horn wrap for protecting the head and horns of a steer is disclosed. In certain examples, the horn wrap includes a body having a main portion and a side portion that extends outward from the main portion, the body formed of a semi-rigid material, where a tip of the side portion is coupled to an end of the main portion, and a stretchable top cord coupled to the main portion and configured to wrap around a horn of a steer. The horn wrap also includes a neck cord coupled to main portion adjacent a bottom edge at a first end. A second horn wrap is also disclosed, and coupled with the first horn wrap via the neck cord. The stretchable top cord is configured to extend from the first horn wrap to the second horn of the steer and subsequently around the second horn wrap

### CROSS-REFERENCES TO RELATED APPLICATIONS

This application claims the benefit of, and claims priority to, U.S. Provisional Patent Application No. 62/983,329 entitled “WRAP FOR PROTECTING THE HEAD AND HORN OF A STEER” and filed on Feb. 28, 2020 for Roy A. Brown, which is incorporated herein by reference.

### FIELD

This disclosure relates generally to protective equipment to be placed on the head and horns of a cattle that are to be roped.

### BACKGROUND

Team roping, or heading and heeling, is an extremely popular part of rodeo events. Team roping features a steer and two mounted riders that chase and catch the steer by roping the head and at least one rear leg of the steer. Frequently, steer that are being chased wear a horn wrap to protect the head, ears, and horns from rope burns and to reduce the risk of a horn breaking when roped. Common horn wraps generally include a pair of interconnected wraps for each horn. An adjustable strap, such as a strap with a buckle, connects the pair of wraps. The adjustable strap allows for different sized steer. To apply a common horn wrap, a person places a wrap over each horn and connects the pair of wraps. This may be difficult depending on how animated the steer is, and whether the chute is accessed from the left or right side of the steer. Depending on the style of horn wrap, it will be easier to place the horn wraps from one side of the chute than the other.

### SUMMARY

A wrap for protecting the head and horns of a steer is disclosed. In certain examples, the wrap includes a body having a main portion and a side portion that extends outward from the main portion, the body formed of a semi-rigid material, where a tip of the side portion is coupled to an end of the main portion, and a stretchable top cord coupled to the main portion and configured to wrap around a horn of a steer. The horn wrap also includes a neck cord coupled to main portion adjacent a bottom edge at a first end.

In certain examples, the semi-rigid material comprises a semi-rigid laminate rubber material. The main portion of the body has a length in the range of between about 12″ and about 15″ and the side portion has a length in the range of between about 4″ and about 7″. In certain examples, the semi-rigid material has a thickness of between about ¼″ and about ½″.

The horn wrap, in certain examples, also includes a fastener that is configured to couple the tip of the side portion to the end of the main portion. The neck cord may be coupled to a bottom edge of a second horn wrap at a second end of the neck cord. In certain examples, the horn wrap includes a plurality of openings formed in the body configured for ventilation, and for receiving the top cord through at least one of the plurality of openings. The top cord may form a loop that passes through two of the plurality of openings.

A system is also disclosed for protecting the horns and head of a steer. The system may include a first horn wrap comprising a first body having a first main portion and a first side portion that extends outward from the first main portion, the first body formed of a semi-rigid material, and where a tip of the first side portion is coupled to an end of the first main portion. The system also includes a second horn wrap comprising a second body having a second main portion and a second side portion that extends outward from the second main portion, the second body formed of the semi-rigid material, and where a tip of the second side portion is coupled to an end of the second main portion.

In certain examples, the system also includes a stretchable top cord coupled to the first main portion and configured to wrap around the horn of the steer, and a neck cord coupled to the first main portion adjacent a bottom edge of the first main portion at a first end of the neck cord and coupled to the second main portion adjacent a bottom edge of the second main portion at a second end of the neck cord.

A method is also provided. The method, in certain examples, includes providing a first horn wrap comprising a first body having a first main portion and a first side portion that extends outward from the first main portion, the first body formed of a semi-rigid material, and where a tip of the first side portion is coupled to an end of the first main portion. The method may also include providing a second horn wrap comprising a second body having a second main portion and a second side portion that extends outward from the second main portion, the second body formed of the semi-rigid material, and where a tip of the second side portion is coupled to an end of the second main portion.

In certain examples, the method also includes positioning the first horn wrap around a first horn of the steer, and positioning the second horn wrap around a second horn of the steer, where a neck cord couples the first horn wrap to the second horn wrap and passes under the head of the steer adjacent the neck of the steer. The method may also include coupling a stretchable top cord that is coupled to the first horn wrap with the second horn of the steer across the top of the head of the steer.

### BRIEF DESCRIPTION OF THE DRAWINGS

A more particular description of the examples briefly described above will be rendered by reference to specific examples that are illustrated in the appended drawings. Understanding that these drawings depict only some examples and are not therefore to be considered to be limiting of scope, the examples will be described and explained with additional specificity and detail through the use of the accompanying drawings, in which:

FIG. 1 is a perspective view diagram illustrating one example of a horn wrap, according to examples of the present disclosure;

FIG. 2 is a top view illustrating one example of the horn wraps positioned on a head of steer, according to examples of the present disclosure;

FIG. 3 is a perspective view of the horn wraps, according to examples of the present disclosure;

FIGS. 4 and 5 are perspective view diagrams of the durable rubber material, according to examples of the present disclosure;

FIG. 6 is a side view illustrating one embodiment of the fastener, according to examples of the present disclosure; and

FIG. 7 is a schematic flow chart diagram illustrating one embodiment of a method for placing the horn wraps, according to examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

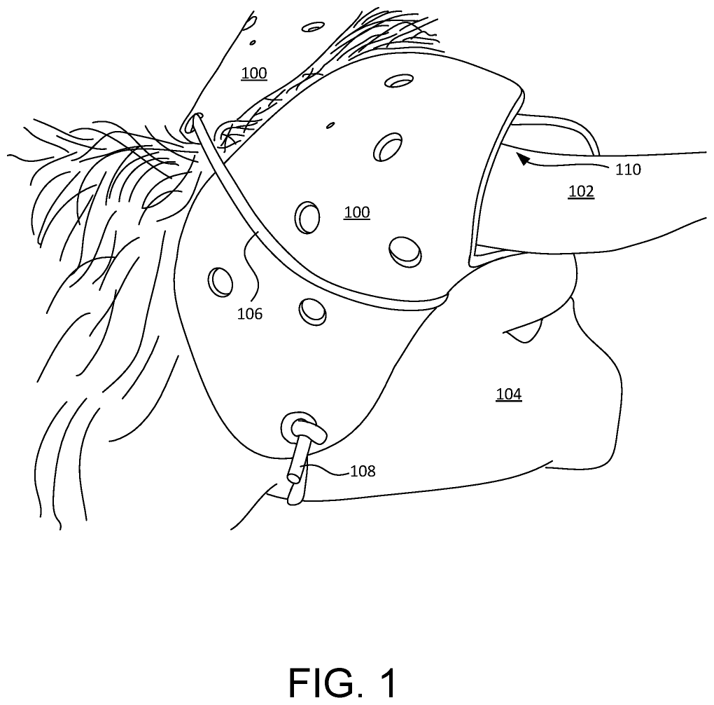

FIG. 1 is a perspective view diagram illustrating one example of a horn wrap 100, according to examples of the present disclosure. The horn wrap 100 is a protective device that is easily positioned on horns 102 of a steer 104. Although the figures, with reference to FIGS. 1-7, depict cattle and the description refers to steer, as used herein, the term “steer” refers to any horned roping animal, and is not gender specific. It is contemplated that the horn wrap 100 of the present disclosure may be sized and adapted to any horned animal that would benefit from horn protection.

In certain embodiments, the horn 102 of the steer 104 extends through the horn wrap 100. A pair of horn wraps 100 are positionable on the steer 104 and connected by a top cord 106 and a bottom or neck cord 108. The top cord 106 and the neck cord 108 secure the horn wraps 100 on the steer 104.

As will be discussed in greater detail below, each of the horn wraps 100 is made of, in part, rubber belting and formed into a semi-conical shape that resembles a funnel having a large opening that is positioned adjacent the head of the steer 104 and a smaller opening 110 through which the horn 102 extends. The rubber belting material, in certain examples, is fiber reinforced. The rubber belting may be formed from an elastomeric material having 100 parts by weight of an at least partially hydrogenated nitrile group-containing copolymer rubber, and from about 0.5 to about 50 parts per hundred weight of a fiber reinforcement. Other compositions of rubber belting are contemplated. Rubber belting which is commonly used for power transmission systems or conveyor belt systems may be used to form the horn wraps 100. In certain examples, the horn wraps 100 are formed using 3/16″ rubber laminate belting with cloth fiber reinforcement.

In certain examples, the top cord 106 and the neck cord 108 are shock cords (i.e., bungee cord). Each of the top cord 106 and the neck cord 108 may be formed with a core having one or more elastic strands that is covered in a woven cotton or polypropylene sheath. The top cord 106 and the neck cord 108 are configured to extend longitudinally (e.g., along a length of the respective cord) between a relaxed state and a fully stretched state. A length of each of the top cord 106 and the neck cord 108 is selected so that the relaxed state is shorter than a measured distance between the horns 102 of the steer 104. Accordingly, when the horn wraps 100 are positioned on the steer 104, the top cord 106 and the neck cord 108 are at least slightly stretched which beneficially helps maintain the horn wraps 100 in position on the steer 104.

In certain examples, the top cord 106 and the neck cord 108 are formed of the same size shock cord. In alternative examples, the top cord 106 is formed of a thinner shock cord than the neck cord 108. In certain examples, the top cord 106 is a ¼″ shock cord having a length in the range of between about 34″ and 38.″ The neck cord 108, in certain examples, is formed of 5/16″ shock cord and has a length in the range of between about 18″ and 21.″

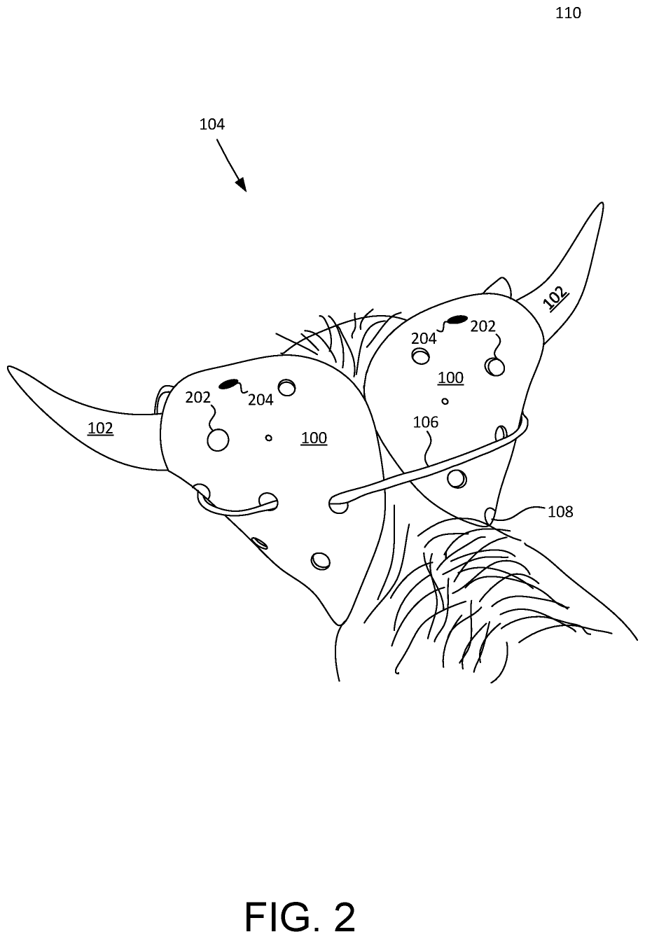

FIG. 2 is a top view illustrating one example of the horn wraps 100 positioned on a head of steer 104, according to examples of the present disclosure. As mentioned above, the horn wraps 100 are positioned over the horns 102 of the steer 104 and secured using the top cord 106 and the neck cord 108. Openings 202 are formed in the rubber belting body of the horn wraps 100 and are useful for ventilation and the placement of the top cord 106 and the neck cord 108.

In certain examples a fastener 204 is inserted into an opening and couples the rubber belting to itself to form the semi-conical shape depicted in FIGS. 1-3. The fastener 204, in some examples, is a #9 rivet. However, it is contemplated that any suitable fastener may be used to “roll up” and keep the horn wrap 100 in the semi-conical configuration.

As depicted here, the top cord 106 is fastened to one of the horn wraps 100 (as depicted, the left horn wrap 100) and stretched over the right-side horn 102 of the steer 104. The top cord 106 secures the horn wraps 100 to the head of the steer 104.

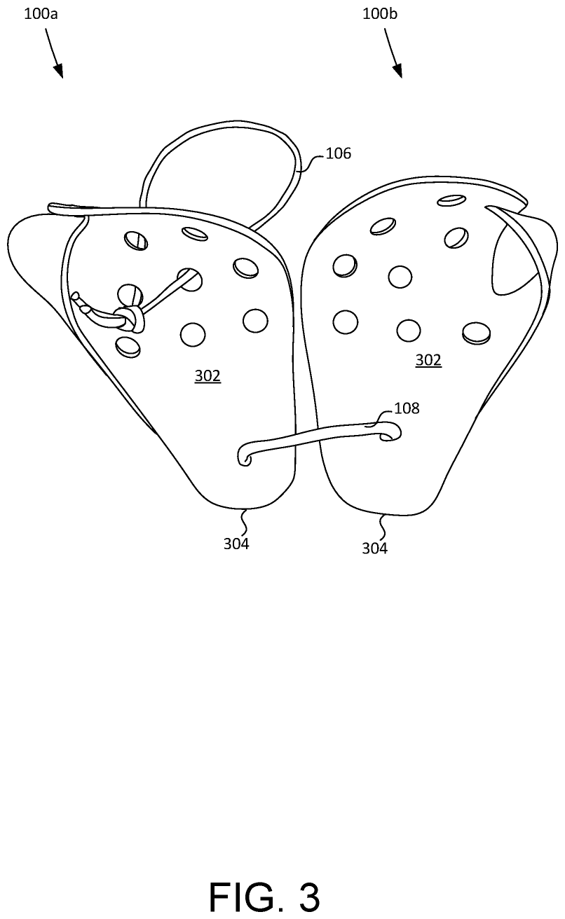

FIG. 3 is a perspective view of the horn wraps 100, according to examples of the present disclosure. The depicted example illustrates an interior surface 302 of the horn wraps 100. As discussed above, the rubber belting is rolled into a semi-conical shape by folding over one side of the horn wrap 100 and attaching to an opposing side of the horn wrap 100 with the fastener 204. The top cord 106 may be in a loop configuration to aid in the placement of the horn wraps 100. Beneficially, a loop configuration of the top cord 106 allows for a quick placement of horn wraps 100 by allowing a person to stretch the top cord 106 across to and around the opposing horn 102 of the steer 104. For example, if the top cord 106 is fastened to the left horn wrap 100a, after the user places both horn wraps, the user extends the top cord 106 around the opposing horn where the right horn wrap 100b is positioned.

The neck cord 108, in certain examples couples the horn wraps 100 near a bottom edge 304. As used herein, the “bottom edge” refers to an area of the horn wrap 100 that would be positioned lowest on the steer 104 nearest the neck. The neck cord 108, accordingly, when positioned, passes under the head of the steer 104 while the top cord 106 passes over the top of the head. The top cord 106 and the neck cord 108 may be in a loop configuration using a simple knot, as depicted. In alternative examples, cord coupling mechanisms may be implemented to form a loop of shock cord. In certain examples, the neck cord 108 couples the left horn wrap 100a with the right horn wrap 100b while the top cord 106 is only coupled with the left horn wrap 100a.

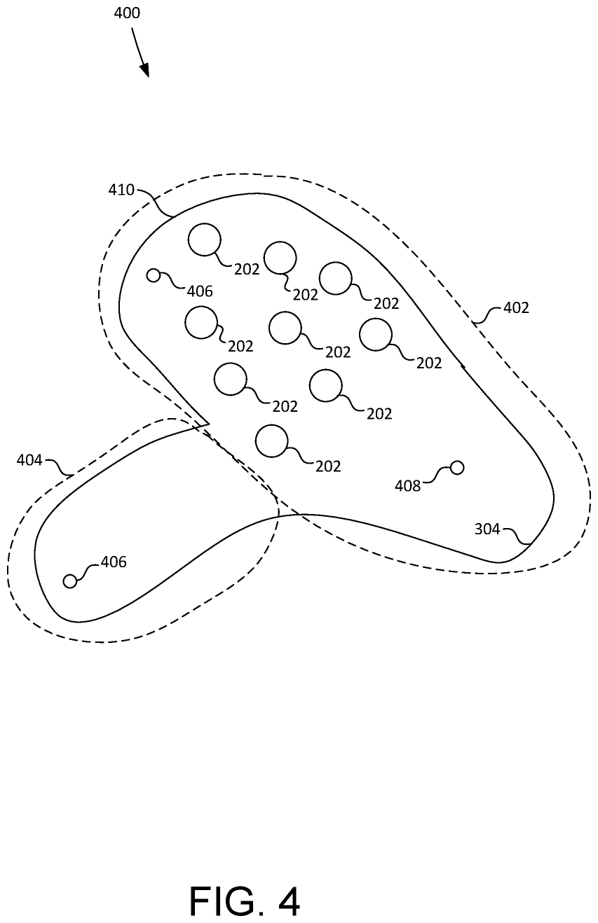

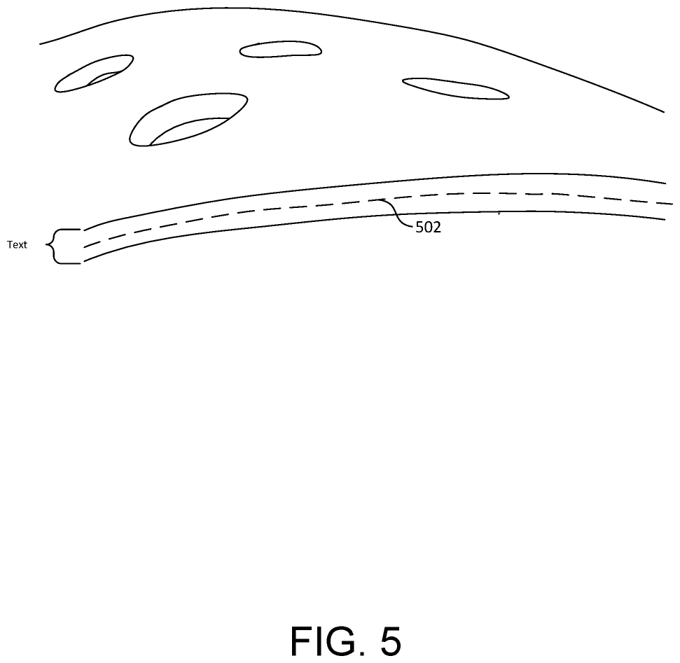

FIGS. 4 and 5 are perspective view diagrams of the durable rubber material, according to examples of the present disclosure. FIG. 4 depicts one example of a suitable shape 400 for forming the semi-conical horn wrap 100. The shape 400 has a main portion 402 and a side portion 404 that extends outward to the side of the main portion 402. FIG. 4 depicts one side of the horn wrap configurations, and the other side may be a mirror image configuration. The side portion 404 includes an opening 406 for receiving the fastener 204. The main portion also includes an opening 406 for the fastener. To form the semi-conical shape, the opening 406 of the side portion 404 is aligned with the opening 406 of the main portion 402. The larger openings 202 may be positioned wherever is convenient for the ventilation of the horn wrap 100 and for attachment points for the top cord 106 and the neck cord 108 (e.g., opening 408).

As described above, and depicted in FIG. 5, the horn wrap 100 is formed of laminate rubber belting with a reinforced fiber, depicted by line 502. The shape 400, in certain examples, is cut or stamped from a sheet. One example is 14″ by 24′ roll of rubber belting that has a thickness 504 that is in the range of between about ¼″ and about ½″. In other examples, the thickness 504 is about 3/16″ thick. As used herein, the term “about” refers to a measurement that is within ±10% of the stated amount. For example, if a length is about 10″, it is intended that lengths between 9″ and 11″ are included. The overall length of the horn wrap 100, in one example, is in the range of between about 12″ and 15″. In some examples, the overall length (from the bottom edge 304 to the opposite edge 410 in a lengthwise direction) is about 13 ¾″. As used herein, the term “about” refers to a range of values that is +−10% of the stated value. The overall width is in the range of between about 12 and about 15 inches. The side portion 404 extends outward from the main portion 402 a distance of between about 4″ and 7″. In another example, the side portion 404 extends outward a distance of about 5 ¾″.

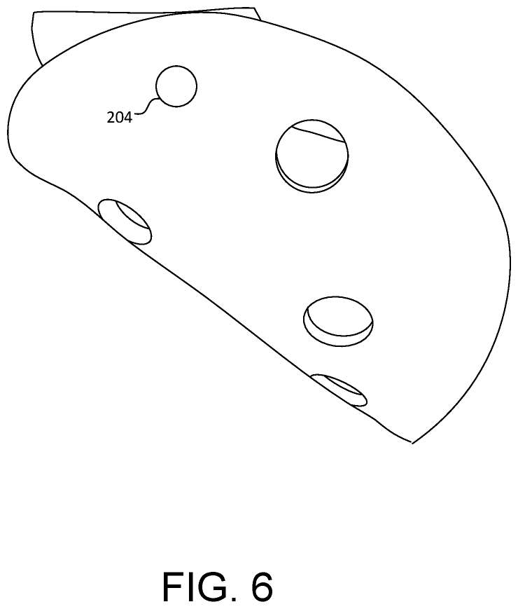

FIG. 6 is a side view illustrating one embodiment of the fastener 204, according to examples of the present disclosure. The fastener 204, as mentioned previously, couples the side portion 404 to the main portion 402 to form the semi-conical shape. The fastener 204 may be a rivet or any other fastener suitable for coupling together two portions of the rubber belting. In certain examples the fastener is removable to allow for cleaning of the horn wrap 100.

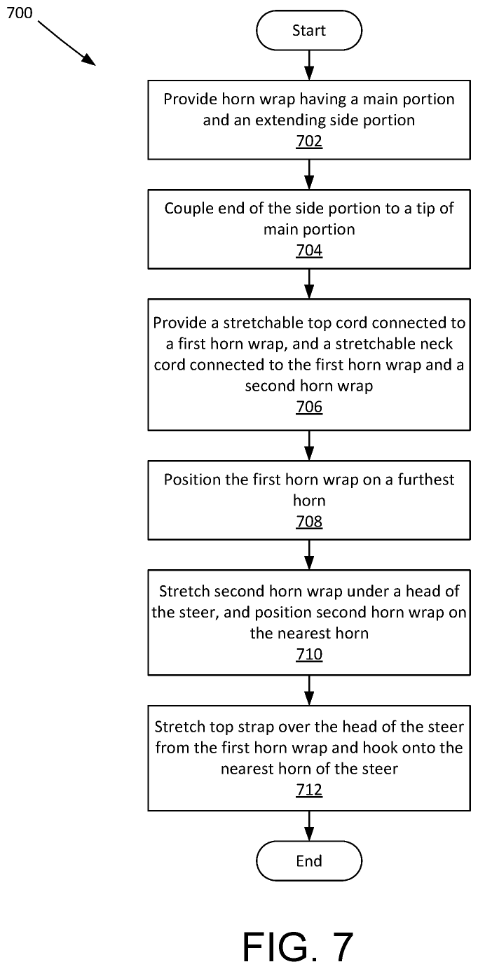

FIG. 7 is a schematic flow chart diagram illustrating one embodiment of a method for placing the horn wraps 100, according to examples of the present disclosure. The method 700 starts and a horn wrap 100 is provided, at block 702, having a main portion 402 and a side portion 404 that extends from the main portion. As described above, the horn wrap 100 may be cut or stamped from a roll of rubber belting. It is contemplated that other semi-rigid, resilient materials may be used. At block 704, the end of the side portion 404 is coupled to a tip of the main portion 402. Openings in the end and the tip are configured to receive a fastener that couples the end of the side portion to the tip of the main portion.

At block 706, stretchable cords are provided to connect pairs of horn wraps. For example, a stretchable top cord is coupled to a first horn wrap, and a stretchable neck cord is coupled to the first horn wrap and a second horn wrap. The top cord, in certain examples, is configured to loop around a horn of a steer, while the neck wrap is configured to pass under the head of the steer and couple the bottom edges 304 of the horn wraps. In alternative examples, the top cord couples together the first horn wrap and the second horn wrap, and the neck cord is permanently coupled to the first horn wrap and removably coupled to the second horn wrap.

At block 708, a person positions the first horn wrap on a furthest horn of the steer. For example, the horn wraps 100 are commonly positioned on the steer when the steer is immobilized in a chute. The person stands on one side or the other of the steer depending on the layout of the chute with relation to the arena. Beneficially, the horn wraps 100 of the present disclosure are positionable from either the left side or the right side of the steer. The person reaches into the chute and places the first horn wrap on the far side horn, and then stretches the second horn, at block 710, under the head of the steer and then positions the second horn wrap on the near side horn. At block 712, the person reaches across the top of the head of the steer, grabs the top cord, and pulls the top cord towards him or herself to hook the top cord onto the near side horn. Removing the horn wraps is accomplished by reversing the steps described with reference to blocks 708, 710, and 712.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A horn wrap for a steer comprising:
a body having a main portion and a side portion that extends outward from the main portion, the body formed of a semi-rigid material, where a tip of the side portion is coupled to an end of the main portion;
a stretchable top cord coupled to the main portion and configured to wrap around a horn of a steer; and
a neck cord coupled to main portion adjacent a bottom edge at a first end.

2. The horn wrap of claim 1, where the semi-rigid material comprises a semi-rigid laminate rubber material.

3. The horn wrap of claim 1, where the main portion of the body has a length in a range of between about 12″ and about 15″.

4. The horn wrap of claim 1, where the side portion of the body has a length in a range of between about 4″ and about 7″.

5. The horn wrap of claim 1, where the semi-rigid material has a thickness of between about ¼″ and about ½″.

6. The horn wrap of claim 1, further comprising a fastener that is configured to couple the tip of the side portion to the end of the main portion.

7. The horn wrap of claim 1, where the neck cord is coupled to a bottom edge of a second horn wrap at a second end of the neck cord.

8. The horn wrap of claim 1, further comprising a plurality of openings formed in the body configured for ventilation, and for receiving the top cord through at least one of the plurality of openings.

9. The horn wrap of claim 8, where the top cord forms a loop that passes through two of the plurality of openings.

10. A system for protecting a head and horns of a steer, the system comprising:
a first horn wrap comprising a first body having a first main portion and a first side portion that extends outward from the first main portion, the first body formed of a semi-rigid material, and where a tip of the first side portion is coupled to an end of the first main portion;
a second horn wrap comprising a second body having a second main portion and a second side portion that extends outward from the second main portion, the second body formed of the semi-rigid material, and where a tip of the second side portion is coupled to an end of the second main portion;
a stretchable top cord coupled to the first main portion and configured to wrap around the horn of the steer; and
a neck cord coupled to the first main portion adjacent a bottom edge of the first main portion at a first end of the neck cord and coupled to the second main portion adjacent a bottom edge of the second main portion at a second end of the neck cord.

11. The system of claim 10, where the semi-rigid material comprises a semi-rigid laminate rubber material.

12. The system of claim 10, where the first main portion of the first body has a length in a range of between about 12″ and about 15″.

13. The system of claim 10, where the first side portion of the first body has a length in a range of between about 4″ and about 7″.

14. The system of claim 10, where the semi-rigid material has a thickness of between about ¼″ and about ½″.

15. The system of claim 10, further comprising a fastener that is configured to couple the tip of the first side portion to the end of the first main portion.

16. The system of claim 10, further comprising a plurality of openings formed in the first body configured for ventilation, and for receiving the top cord through at least one of the plurality of openings.

17. The system of claim 16, where the top cord forms a loop that passes through two of the plurality of openings.

18. A method for protecting a head and horns of a steer, the method comprising:
providing a first horn wrap comprising a first body having a first main portion and a first side portion that extends outward from the first main portion, the first body formed of a semi-rigid material, and where a tip of the first side portion is coupled to an end of the first main portion;
providing a second horn wrap comprising a second body having a second main portion and a second side portion that extends outward from the second main portion, the second body formed of the semi-rigid material, and where a tip of the second side portion is coupled to an end of the second main portion;
positioning the first horn wrap around a first horn of the steer;
positioning the second horn wrap around a second horn of the steer, where a neck cord couples the first horn wrap to the second horn wrap and passes under the head of the steer adjacent the neck of the steer; and
coupling a stretchable top cord that is coupled to the first horn wrap with the second horn of the steer across the top of the head of the steer.

19. The method of claim 18, where the semi-rigid material comprises a semi-rigid laminate rubber material.

20. The method of claim 19, where the semi-rigid material has a thickness of between about ¼″ and about ½″.
